(19) United States
(12) Patent Application Publication
(10) Pub. No.: US 2012/0324559 A1
(43) Pub. Date: Dec. 20, 2012

(54) ESTABLISHING A SECURE CONNECTION BASED ON A JOINT GESTURE

(75) Inventors: Alexander S. Ran, Palo Alto, CA (US); Ajay Tripathi, San Ramon, CA (US)

(73) Assignee: INTUIT INC., Mountain View, CA (US)

(21) Appl. No.: 13/160,353

(22) Filed: Jun. 14, 2011

(51) Int. Cl. G06F 21/20

(52) U.S. Cl. 726/9

(57) ABSTRACT

During a transaction, an electronic device (such as a cellular telephone) captures a gesture performed by a user of the electronic device. This gesture is analyzed to determine salient features, such as accelerations of the electronic device during the gesture and associated time intervals. Then, the electronic device generates a token based on the salient features, and provides the token to a server. When a second token, associated with the token, is received by the server from a second electronic device, the server establishes a secure connection between the electronic device and the second electronic device.

### BACKGROUND

The present disclosure relates to techniques for establishing a secure connection between electronic devices during a transaction based on gestures performed when using the electronic devices.

Financial and legal transactions, for example involving reservations, quotes, payments, agreements and contracts, are often performed during face-to-face interactions. In principle, portable electronic devices, such as cellular telephones, can be useful tools in facilitating these interactions. For example, cellular telephones can be used to digitally capture content during an interaction, and then seamlessly integrate the content into backend systems, such as: legal or financial management systems, payment networks or banking systems.

However, in order to use portable electronic devices to facilitate face-to-face interactions, a secure session or connection typically has to be established between the participants' portable electronic devices. In particular, in order to establish a secure connection, a secure pairing and a confidential communication channel usually need to be established between paired portable electronic devices.

Existing techniques for establishing such a secure connection are often cumbersome and/or impractical. For example, many techniques leverage trust between the participants or an offline certification authority. However, these approaches are not suitable when the participants have no prior direct or indirect trust relationship.

Alternatively, a secure connection can be implemented using physical security, for example, by coupling the portable electronic devices using a physical cable, and restricting communications to be over the physically secured connection. However, this is often impractical because of the absence of a universal cable to connect two arbitrarily selected portable electronic devices and the need for a face-to-face interaction.

Furthermore, several existing techniques for establishing a secure connection leverage additional capabilities, such as absolute time and location measurements, which are not available on all portable electronic devices, and which may not have sufficient resolution to reliably establish the secure connection. Additionally, techniques have been proposed based on proximity of the portable electronic devices and shared information in the physical environment, such as images of bar-codes or audible information. However, these proposed techniques are complicated, and may be vulnerable to security breaches by a third party who intercepts the shared information.

The above-described lack of reliability and usage problems makes it harder for users to conduct transactions via portable electronic devices.

### SUMMARY

The disclosed embodiments relate to an electronic device that establishes a secure connection with a second electronic device. During a transaction, the electronic device captures a gesture performed by a user of the electronic device. Then, the electronic device analyzes the gesture to determine salient features. Moreover, the electronic device generates a token based on the salient features. Next, the electronic device provides the token to a server, which establishes a secure connection between the electronic device and the second electronic device when a second token, associated with the token, is received by the server from the second electronic device.

Note that the second token may be the same as the token. Furthermore, the second token may be associated with another gesture made by another user of the second electronic device, where the gesture and the other gesture are, respectively, performed by the user and the other user within a time interval.

Additionally, the gesture and the other gesture may correspond to a common gesture, such as a time-varying spatial displacement of the electronic device. For example, after topological morphing, the gesture and the other gesture may be the same. In some embodiments, the topological morphing includes dynamic time warping.

In some embodiments, the salient features include accelerations of the electronic device during the gesture and associated time intervals.

Moreover, the secure connection may include a secure peer-to-peer connection between the electronic device and the second electronic device so that secure communication during the transaction physically occurs between the electronic device and the second electronic device. Alternatively, the secure connection between the electronic device and the second electronic device may be implemented in the server so that secure communication during the transaction occurs in the server.

Another embodiment provides a method that includes at least some of the operations performed by the electronic device.

Another embodiment provides a computer-program product for use with the electronic device. This computer-program product includes instructions for at least some of the operations performed by the electronic device.

### BRIEF DESCRIPTION OF THE FIGURES

FIG. 1 is a flow chart illustrating a method for establishing a secure connection in accordance with an embodiment of the present disclosure.

FIG. 2 is a flow chart illustrating the method of FIG. 1 in accordance with an embodiment of the present disclosure.

FIG. 3 is a block diagram illustrating a gesture performed using an electronic device during the method of FIG. 1 in accordance with an embodiment of the present disclosure.

FIG. 4 is a block diagram illustrating a system that performs the method of FIGS. 1 and 2 in accordance with an embodiment of the present disclosure.

FIG. 5 is a block diagram illustrating an electronic device that performs the method of FIGS. 1 and 2 in accordance with an embodiment of the present disclosure.

FIG. 6 is a block diagram illustrating a data structure for use in the electronic device of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a system that includes the electronic device, a technique for establishing a secure connection, and a computer-program product (e.g., software) for use with the electronic device are described. During a transaction, the electronic device (such as a cellular telephone and, more generally, a portable electronic device) captures a gesture performed by a user of the electronic device. This gesture is analyzed to determine salient features, such as accelerations of the electronic device during the gesture and associated time intervals. Then, the electronic device generates a token based on attributes of the salient features or the gesture (such as for example the sequence of time intervals between the detected salient features), and provides the token to a server. When a second token, associated with the token, is received by the server from a second electronic device, the server establishes a secure connection between the electronic device and the second electronic device.

By facilitating the secure connection, this security technique may improve usability and increase user confidence in conducting transactions via electronic devices. By improving the usability and security of face-to-face financial transactions, this security technique may lead to increasing commercial activity.

In the discussion that follows, the user may include one of a variety of entities, such as: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

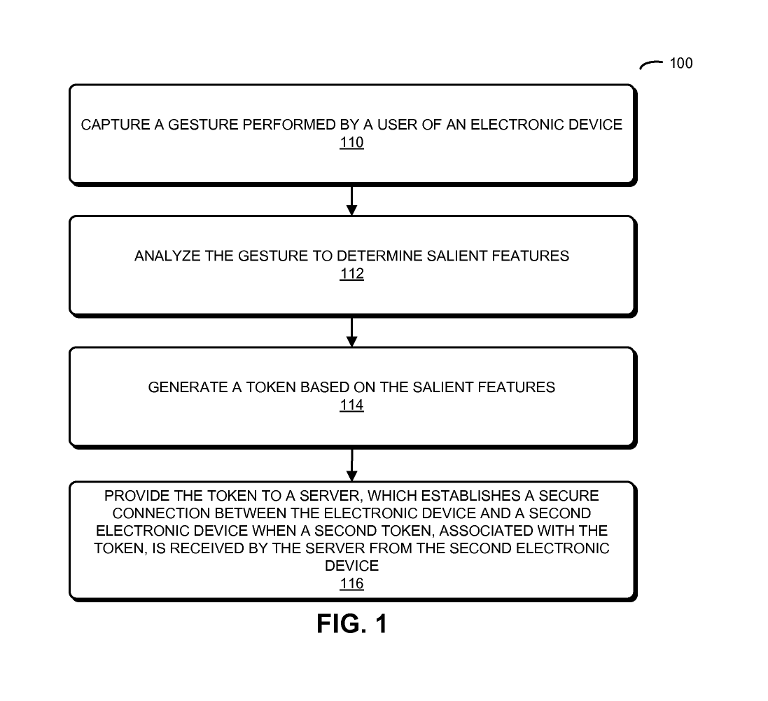

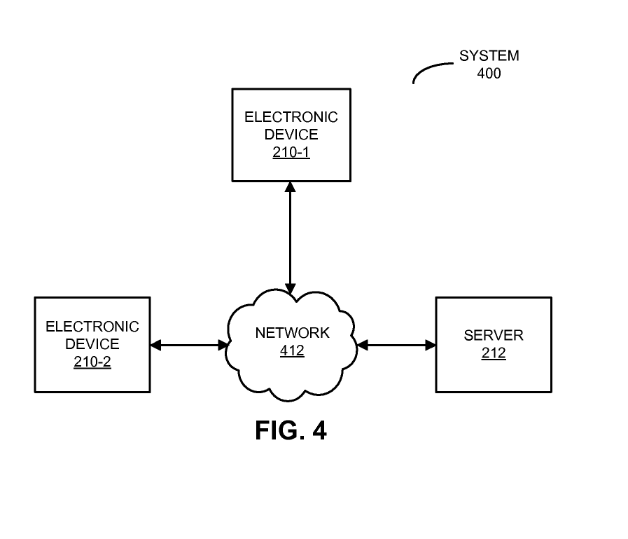

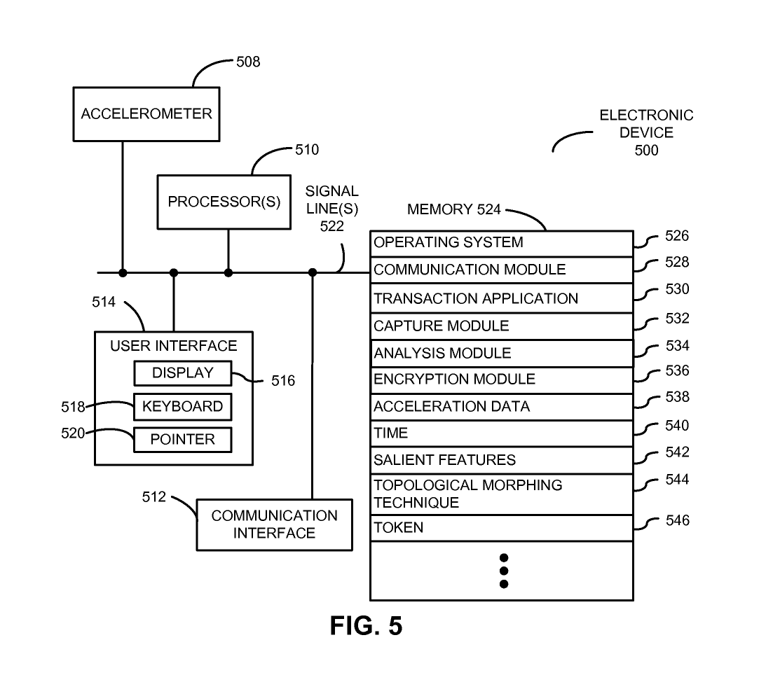

We now describe embodiments of the security technique. FIG. 1 presents a flow chart illustrating a method 100 for establishing a secure connection, which may be performed by a system (such as system 400 in FIG. 4) and/or an electronic device (such as electronic device 500 in FIG. 5). During a transaction, the electronic device captures a gesture performed by a user of an electronic device (operation 110). For example, the gesture may be performed approximately synchronously by the user of the electronic device and another user of a second electronic device.

Then, the electronic device analyzes the gesture to determine salient features (operation 112), such as accelerations of the electronic device during the gesture and associated time intervals. Moreover, the electronic device generates a token based on the salient features (operation 114).

Next, the electronic device provides the token to a server, which establishes a secure connection between the electronic device and the second electronic device when a second token, associated with the token, is received by the server from the second electronic device (operation 116). Note that the second token may be the same as the token. Thus, if two electronic devices ‘know’ the same token (such as a number) in this way, the server can establish a secure connection.

Furthermore, the second token may be associated with another gesture made by the other user of the second electronic device, where the gesture and the other gesture are, respectively, performed by the user and the other user within a time interval, such as one or two seconds.

Additionally, the gesture and the other gesture may correspond to a common gesture, such as a time-varying spatial displacement of the electronic device. For example, after topological morphing, the gesture and the other gesture may be the same. In some embodiments, the topological morphing includes dynamic time warping, remapping or rescaling.

Moreover, the secure connection may include a secure peer-to-peer connection between the electronic device and the second electronic device so that secure communication during the transaction physically occurs between the electronic device and the second electronic device. Alternatively, the secure connection between the electronic device and the second electronic device may be implemented in the server so that secure communication during the transaction occurs in the server.

In this way, a joint or common gesture performed by the users of the two electronic devices can be used to generate a common token or number. In principle, the electronic devices can make any arbitrary gesture together, and the token may be generated based on at least some of the salient features in the gesture or their attributes (such as the time intervals between successively detected salient features of the gesture).

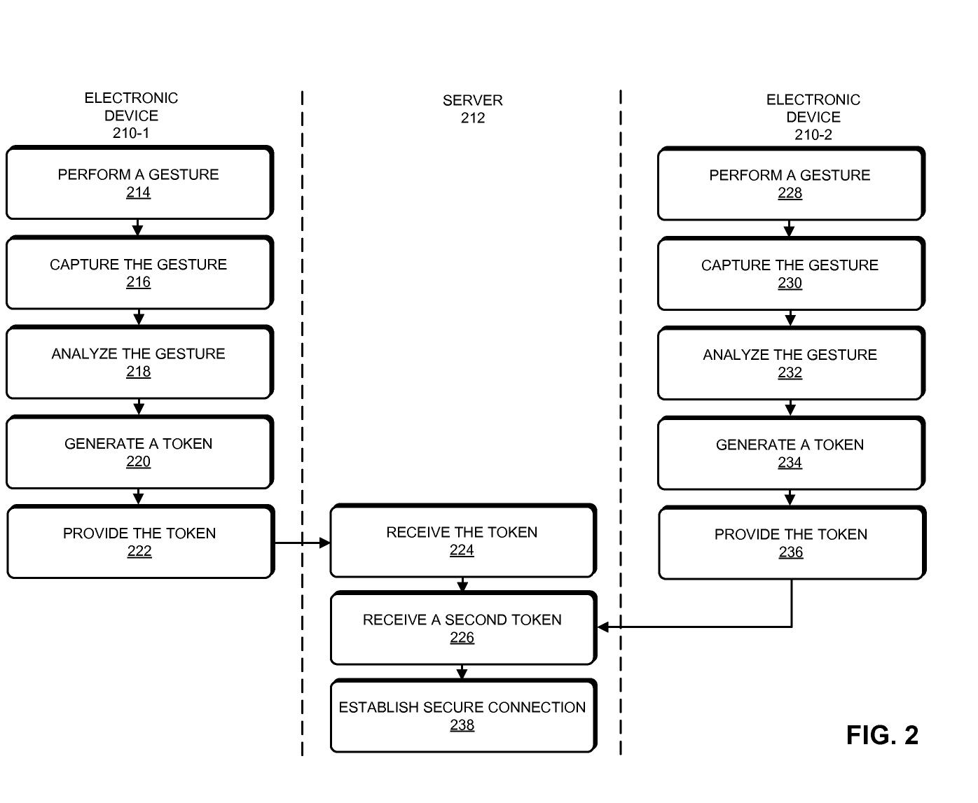

In an exemplary embodiment, the security technique is implemented using one or more electronic devices and at least one server computer, which communicate through a network, such as a cellular-telephone network and/or the Internet (e.g., using a client-server architecture). This is illustrated in FIG. 2, which presents a flow chart illustrating method 100. During this method, a user may perform a gesture using electronic device 210-1, e.g., a computer or a portable electronic device, such as a cellular telephone (operation 214). For example, the gesture may include a time-varying spatial displacement of electronic device 210-1.

Electronic device 210-1 may capture the gesture (operation 216). Then, electronic device 210-1 may analyze the gesture to determine the salient features (operation 218), such as accelerations of the electronic device during the gesture and associated time intervals. Note that analyzing the gesture may include topological morphing, such as dynamic time warping, remapping or rescaling.

Moreover, electronic device 210-1 may generate a token (such as a number) based on the salient features (operation 220). This token may be provided to (operation 222) and received by (operation 224) server 212. Server 212 may also receive a second token (operation 226), associated with the token, from another electronic device. In particular, another user of electronic device 210-2 may make a joint gesture with the user of electronic device 210-1 (for example, approximately synchronously with the user), and the second token may be generated and provided in operations 228-236.

After receiving the token and the second token, server 212 may establish a secure connection (operation 238) between electronic device 210-1 and the other electronic device. For example, server 212 may establish the secure connection if the tokens are the same.

In some embodiments of method 100 (FIGS. 1 and 2), there may be additional or fewer operations. For example, if server 212 receives more than two similar or identical tokens within a time interval (such as 10 s) from electronic devices that are in proximity to each other (such as within 5-10 m), the server may conclude that more than two parties are trying to establish a secure connection using the same credentials. As a consequence, server 212 may not establish the secure connection. (However, in some embodiments the security technique is used to implement a secure connection between more than two electronic devices.) Moreover, the order of the operations may be changed, and/or two or more operations may be combined into a single operation.

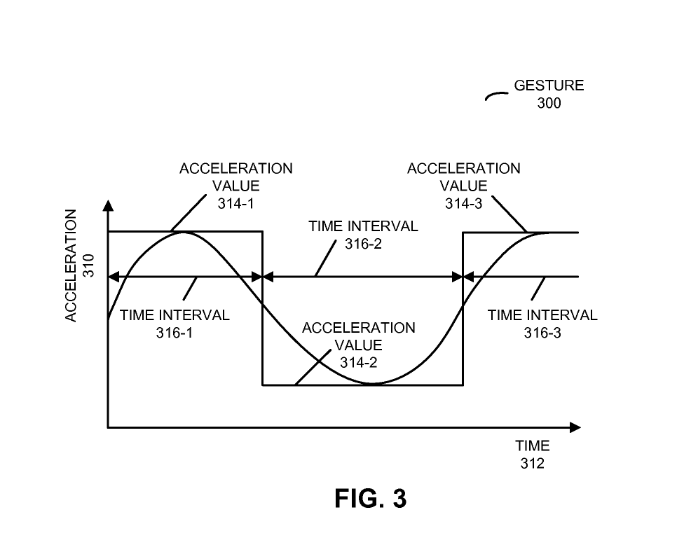

FIG. 3 presents a block diagram illustrating a gesture 300 performed using an electronic device (such as electronic device 210-1 in FIG. 2) during method 100 (FIG. 1). This gesture includes acceleration 310 (or velocity or spatial displacement information) of the electronic device as a function of time 312, which may be determined by a sensor in the electronic device (such as a relative or absolute displacement sensor, a velocity sensor and/or an accelerometer). After the topological morphing, the salient features may be extracted from gesture 300, including acceleration values 314 and associated time intervals 316.

Thus, a secure pairing and a confidential communication channel can be established between paired electronic devices if the two electronic devices securely establish a shared secret such as a large number known only to these electronic devices. This shared secret can be determined from accelerometer data collected while the electronic devices participate in an arbitrary joint gesture. For example, during the gesture, users may: perform a handshake, shake their cellular telephones up and down several times while touching their hands, and/or one person can hold two cellular telephones in their hand(s) and shake them together. More generally, the users may perform an arbitrary gesture in space during a short interval of time using both cellular telephones, such as a complicated spatial trajectory that is accomplished by moving the two electronic devices together for 1 or 2 seconds.

Moreover, the accelerometer data can be used to recognize a limited vocabulary of reliably detectable salient features of the gesture (such as, for example, a reversal of spatial direction). These salient features may include the sequence of time intervals between successively recognized features on each electronic device. Note that, by relying on time intervals, synchronization problems and rounding of the measured time intervals can be avoided to reduce or eliminate measurement precision errors, which allows the same number or token to be determined for a given gesture.

In an exemplary embodiment, each of the electronic devices may perform the same salient-feature detection technique on a stream of accelerometer measurements. Initially, noise may be eliminated from the accelerometer samples using a low-pass filter. In addition, a threshold can be applied to the measurements to limit the effect of unintentional (or undefined), slow movement of the electronic devices.

Moreover, the salient-feature detection may be defined algorithmically. For example, a reversal in the direction of movement may be recognized. If an electronic device is at rest at the beginning of a particular movement, directional reversal can be detected when the integral of the acceleration over an appropriately selected time window covers the range [ν, −ν] where |ν| is the magnitude of the minimum velocity of the electronic device that indicates an intentional gesture.

In a more extendable implementation, the salient features may be defined by a small ‘vocabulary’ or set of templates stored on the electronic device in the form of normalized sequences of accelerometer samples. These feature templates can be defined based on sampling of gestures during a training process or procedure. In addition, the feature templates may be updated and personalized to improve performance. Feature detection may be performed by matching a running window of accelerometer samples to the stored feature templates. In order to accommodate variation in the timing of gestures, the matching may include dynamic time warping. More generally, curve or time-sequence measurement mapping may be used. Then, once n+1 features are detected, the time intervals (Tₙ) between the detected salient features may be determined. Because each salient feature has finite duration, the mid-point of the salient feature may be used to calculate the time intervals between salient features.

Next, the calculated time intervals may be rounded to eliminate measurement precision and calibration errors. Furthermore, a function F may be applied to Tₙ to produce a single token or number S, which equals F(T₁, T₂, . . . Tₙ), on all the electronic devices that participated in the joint gesture. This shared secret can be used to pair electronic devices, as well as to encrypt the data communicated between the electronic devices.

We now describe embodiments of the system and the electronic device, and their use. FIG. 4 presents a block diagram illustrating a system 400 that performs method 100 (FIGS. 1 and 2). In this system, users of electronic devices 210 may perform gestures (such as time-varying spatial displacements of electronic devices 210) during a transaction (such as a financial transaction) while using a software application. This software application may be resident on and may execute on electronic devices 210. Alternatively, the users may interact with a web page that is provided by server 212 via network 412, and which is rendered by a web browser on electronic devices 210. For example, at least a portion of the software application may be an application tool that is embedded in the web page, and which executes in a virtual environment of the web browser. Thus, the software application tool may be provided to the user via a client-server architecture. Furthermore, the software application may be a standalone application or a portion of another application that is resident on and which executes on electronic devices 210.

Electronic devices 210 may capture the gestures. Then, the software application on each of electronic devices 210 may analyze the gestures to determine the salient features, such as accelerations of the electronic device during the gestures and associated time intervals. As noted previously, this analysis may involve topological morphing, such as dynamic time warping, remapping or rescaling.

Next, electronic devices 210 may generate tokens based on the determined salient features. These tokens may be provided to server 212 via network 412. If the tokens are the same, and if they are received by server 212 within a given time interval (such as 1-10 s), server 212 may establish a secure connection between electronic devices 210. For example, the secure connection may include a secure peer-to-peer connection between electronic devices 210 so that secure communication during the transaction physically occurs between electronic devices 210. Alternatively, the secure connection between electronic devices 210 may be implemented in server 212 (such as in software) so that secure communication during the transaction occurs in server 212.

Note that information in system 400 may be stored at one or more locations in system 400 (i.e., locally or remotely). Moreover, because this data may be sensitive in nature, at least some of it may be encrypted. For example, at least some of the stored data and/or the data communicated via network 412 may be encrypted.

FIG. 5 presents a block diagram illustrating an electronic device 500 that performs method 100 (FIGS. 1 and 2), such as electronic device 210-1 (FIGS. 2 and 4). Electronic device 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in electronic device 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to electronic device 500.

Memory 524 may also include multiple program modules (or sets of instructions), including: transaction application 530 (or a set of instructions), capture module 532 (or a set of instructions), analysis module 534 (or a set of instructions), and/or encryption module 536 (or a set of instructions). Note that one or more of these program modules (or sets of instructions) may constitute a computer-program mechanism.

During method 100 (FIGS. 1 and 2), a user may perform a gesture while using transaction application 530 on electronic device 500. When the user performs the gesture, capture module 532 may capture or collect acceleration data 538 as a function of time 540 from accelerometer 508. Then, analysis module 534 may analyze the data to determine salient features 542. Moreover, the analysis may involve a topological morphing technique 544.

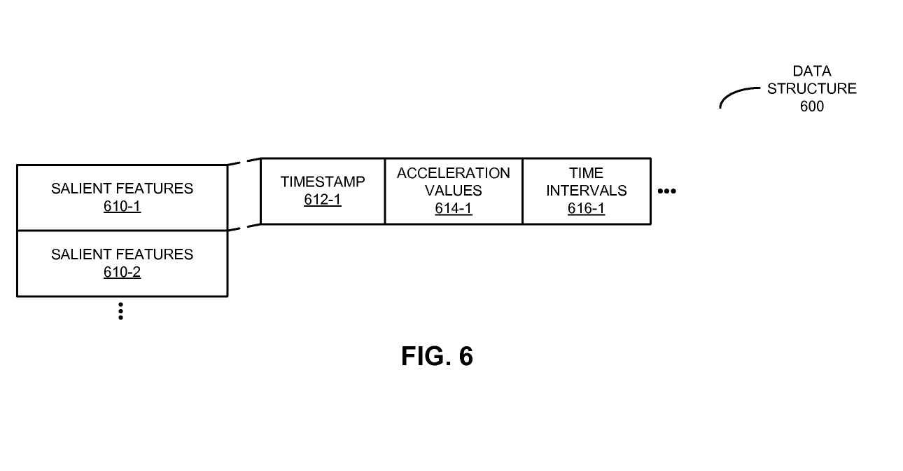

FIG. 6 illustrates a data structure 600 that includes determined salient features 610. For example, salient features 610-1 may include: a timestamp 612-1 at a start of a gesture, acceleration values 614-1, and associated time intervals 616-1.

Referring back to FIG. 5, transaction application 530 may generate a token 546 based on salient features 542. Communication module 528 may provide this token to server 212 (FIGS. 2 and 4) via communication interface 512, where it may be used to establish a secure connection with another electronic device during the transaction.

Because information in electronic device 500 may be sensitive in nature, in some embodiments at least some of the data stored in memory 524 and/or at least some of the data communicated using communication module 528 is encrypted using encryption module 536.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510.

Although electronic device 500 is illustrated as having a number of discrete items, FIG. 5 is intended to be a functional description of the various features that may be present in electronic device 500 rather than a structural schematic of the embodiments described herein. In practice, and as recognized by those of ordinary skill in the art, the functions of electronic device 500 may be distributed over a large number of servers or computers, with various groups of the servers or computers performing particular subsets of the functions. In some embodiments, some or all of the functionality of electronic device 500 may be implemented in one or more application-specific integrated circuits (ASICs) and/or one or more digital signal processors (DSPs).

Electronic devices (such as electronic device 500), as well as computers and servers in system 400 (FIG. 4) may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 412 (FIG. 4) may include: the Internet, World Wide Web (WWW), an intranet, a cellular-telephone network, LAN, WAN, MAN, or a combination of networks, or other technology enabling communication between computing systems.

In some embodiments one or more of the modules in memory 524, such as transaction application 530, may be associated with and/or included in a financial application. This financial application may include: Quicken™ and/or TurboTax™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC, of St. Paul, Minn.), and/or other planning software capable of processing financial information.

Moreover, the financial application may be associated with and/or include software such as: QuickBooks™ (from Intuit, Inc., of Mountain View, Calif.), Peachtree™ (from The Sage Group PLC, of Newcastle Upon Tyne, the United Kingdom), Peachtree Complete™ (from The Sage Group PLC, of Newcastle Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), Tally.ERP (from Tally Solutions, Ltd., of Bangalore, India) and/or other payroll or accounting software capable of processing payroll information.

System 400 (FIG. 4), electronic device 500 (FIG. 5) and/or data structure 600 may include fewer components or additional components. Moreover, two or more components may be combined into a single component, and/or a position of one or more components may be changed. In some embodiments, the functionality of system 400 (FIG. 4) and/or electronic device 500 may be implemented more in hardware and less in software, or less in hardware and more in software, as is known in the art.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic-device-implemented method for establishing a secure connection, the method comprising:
during a transaction, capturing a gesture performed by a user of an electronic device;
using the electronic device, analyzing the gesture to determine salient features;
generating a token based on the salient features; and
providing the token to a server, which establishes a secure connection between the electronic device and a second electronic device when a second token, associated with the token, is received by the server from the second electronic device.

2. The method of claim 1, wherein the second token is the same as the token.

3. The method of claim 1, wherein the second token is associated with another gesture made by another user of the second electronic device; and
wherein the gesture and the other gesture are, respectively, performed by the user and the other user within a time interval.

4. The method of claim 1, wherein the gesture and the other gesture correspond to a common gesture.

5. The method of claim 1, wherein, after topological morphing, the gesture and the other gesture are the same.

6. The method of claim 5, wherein the topological morphing includes dynamic time warping.

7. The method of claim 1, wherein the gesture includes a time-varying spatial displacement of the electronic device.

8. The method of claim 1, wherein the salient features include accelerations of the electronic device during the gesture and associated time intervals.

9. The method of claim 1, wherein the secure connection includes a secure peer-to-peer connection between the electronic device and the second electronic device so that secure communication during the transaction physically occurs between the electronic device and the second electronic device.

10. The method of claim 1, wherein the secure connection between the electronic device and the second electronic device is implemented in the server so that secure communication during the transaction occurs in the server.

11. A non-transitory computer-program product for use in conjunction with a computer system, the computer-program product comprising a computer-readable storage medium and a computer-program mechanism embedded therein, to establish a secure connection, the computer-program mechanism including:
during a transaction, instructions for capturing a gesture performed by a user of an electronic device;
instructions for analyzing the gesture to determine salient features;
instructions for generating a token based on the salient features; and
instructions for providing the token to a server, which establishes a secure connection between the electronic device and a second electronic device when a second token, associated with the token, is received by the server from the second electronic device.

12. The computer-program product of claim 11, wherein the second token is the same as the token.

13. The computer-program product of claim 11, wherein the second token is associated with another gesture made by another user of the second electronic device; and
wherein the gesture and the other gesture are, respectively, performed by the user and the other user within a time interval.

14. The computer-program product of claim 11, wherein the gesture and the other gesture correspond to a common gesture.

15. The computer-program product of claim 11, wherein, after topological morphing, the gesture and the other gesture are the same.

16. The computer-program product of claim 15, wherein the topological morphing includes dynamic time warping.

17. The computer-program product of claim 11, wherein the gesture includes a time-varying spatial displacement of the electronic device.

18. The computer-program product of claim 11, wherein the salient features include accelerations of the electronic device during the gesture and associated time intervals.

19. The computer-program product of claim 11, wherein the secure connection includes a secure peer-to-peer connection between the electronic device and the second electronic device so that secure communication during the transaction physically occurs between the electronic device and the second electronic device.

20. The computer-program product of claim 11, wherein the secure connection between the electronic device and the second electronic device is implemented in the server so that secure communication during the transaction occurs in the server.

21. A computer system, comprising:
a processor;
memory; and
a program module, wherein the program module is stored in the memory and configurable to be executed by the processor to establish a secure connection, the program module including:
during a transaction, instructions for capturing a gesture performed by a user of an electronic device;
instructions for analyzing the gesture to determine salient features;
instructions for generating a token based on the salient features; and
instructions for providing the token to a server, which establishes a secure connection between the electronic device and a second electronic device when a second token, associated with the token, is received by the server from the second electronic device.
